(19) United States
(12) Patent Application Publication
(10) Pub. No.: US 2007/0266602 A1
(43) Pub. Date: Nov. 22, 2007

(54) Business card

(76) Inventor: Sepehr Daghighian, Pacific Palisades, CA (US)

Correspondence Address: Sepehr Daghighian, # 201C, 17350 W. Sunset Blvd., Pacific Palisades, CA, 90272, US

(21) Appl. No.: 11/411,534

(22) Filed: Apr. 26, 2006

(51) Int. Cl. G09F 7/00

(52) U.S. Cl. 40/492

(57) ABSTRACT

This invention discloses a business card that allows information to be selectively and dynamically displayed by the user and presents an overall eye-catching and attractive design.

### FIELD OF INVENTION

This invention relates, generally, to business cards; more particularly to business cards that feature a system for selectively displaying and hiding information.

### BACKGROUND

The conventional business card successfully conveys a certain amount of information about the cardholder. Business persons are, however, challenged to present business cards that attract attention and create a memorable impact in the minds of colleagues and potential clients. Thus, printing techniques such as embossing, color printing, photographic printing, two sided printing and other such techniques are commonly employed to create attractive cards, which will hopefully not be ignored and flippantly crammed into the recipient's nearest pocket. Unfortunately, however, all too often, even these techniques are insufficient to receive more than a passing glance overcome the recipient's fleeting concentration.

Another problem with conventional business cards is that they convey all of the information in a static manner. That is, all the information that the card has to offer is conveyed at exactly the same time. Thus, the recipient is unable to selectively review information according the information the recipient desires at a given moment. Moreover, the card is unable to convey varying information at different times in a dynamic manner. Lenticular business cards have been developed which allow a dynamic approach to conveying information. These cards, however, are relatively expensive and remain susceptible to the shortcomings of conventional business cards discussed above.

Thus, there is a long-felt need in the art for a business card design that will both retain the recipient's attention and convey information in a selective, dynamic, and interactive manner.

### SUMMARY OF THE INVENTION

This invention is directed towards overcoming the above shortcomings by disclosing a business card design that allows the information contained on the card to be conveyed in a selective, dynamic, and interactive manner, thus, creating a greater impression in the mind of the card's recipient.

Unlike conventional business cards, the invention is comprised of two or more parts. In one embodiment of the invention, the card is comprised of an outer card and an inner disk. The outer card may convey some printed information, includes a thumb notch for turning the inner disk, and contains one or more windows through which the disk may be viewed. The inner disk contains further printed information that only may be viewed when aligned with the one or more windows of the outer card. Thus, by selectively rotating the disk within the outer card, the viewer is able to select the information that is conveyed through the one or more windows.

In one embodiment of the invention, for example, the outer card contains two windows through which information may be viewed. The first window contains category information such as: “Name, Address, Phone Number, Fax Number, and Email Address” and the second window conveys the related written information for the cardholder. Thus, a recipient may selectively view the cardholder's name, address, phone number, or further such information as the recipient so chooses. All of the information may not be viewed at once because the bulk of the disk's information remains covered by the outer disk. Thus, the information is conveyed in a selective and dynamic manner.

In another embodiment of the invention, the first window contains information on locations of varying branches of a given business. The second window, in turn, conveys the contact information on those numerous branches. Thus, by rotating the disk and selecting a location in the first window, the card's recipient is able to selectively view the selected branch's contact information through the second window.

In another embodiment of the invention, the outer card includes windows on both the front and back of the card and the inner disk contains information on both of its sides. Thus, by information may be selectively displayed on the front or the back of the card. For example, the front of the disk may include an image of a globe with selected cities that the business has branch locations. As locations are selected through a window in the front of the card, the contact information for the branch is presented through a window in the back of the card.

In another embodiment of the invention, windows on both the front and back may be used to convey unrelated information. For example, windows on the front of the card may be used to convey contact information in the manner described above. Meanwhile, windows on the back of the card may be used to convey other information, such as services provided. In this manner the card allows the recipient to dynamically and selectively view information regarding the cardholder.

In yet another embodiment of the invention, the disk contains image slides or pictures that are viewed as the disk is rotated across window on the outer disk. In this manner, an animation or animated scene may be viewed by rotating the disk.

In summary, the invention discloses a novel means by which information may be conveyed in a selective and dynamic manner in a business card that is attractive and captivating.

### BRIEF DESCRIPTION OF THE DRAWINGS

FIG. 1A is an top view of the outer card in one embodiment of the invention.

FIG. 1B is a top view of the inner disk in one embodiment of the invention.

FIGS. 2A, 2B, 2C, and 2D are top views of the business card invention while selectively displaying different information.

### DETAILED DESCRIPTION OF THE DRAWINGS

In the following detailed description of various embodiments of the invention, numerous specific details are set forth in order to provide a thorough understanding of various aspects of one or more embodiments of the invention. However, one or more embodiments of the invention may be practiced without these specific details. In other instances, well-known methods, procedures, and/ or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive. Also, the reference or non-reference to a particular embodiment of the invention shall not be interpreted to limit the scope the invention.

Moreover, in the following description, certain terminology is used to describe certain features of one or more embodiments of the invention. This terminology shall not however be construed to limit the scope of the invention. “Business card” refers to any paper, plastic, or other type of card that is generally used to convey information; “window” refers to any cut-out in said business card such that information may be viewed through said window; and “printed information” refers to any printed matter including text, images, or a combination of text and images.

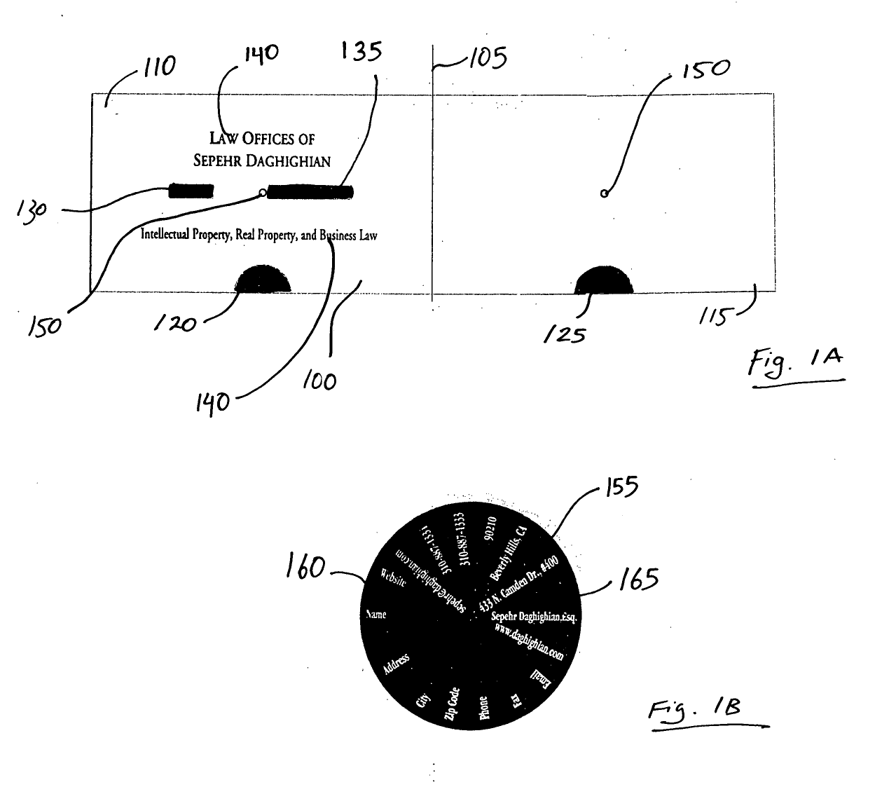

FIG. 1A is an top view of the outer card in one embodiment of the invention. The outer card 100 is shown along with the fold line 105, which divides the outer card 100 into a front outer card 110 and a back outer card 115. The front outer card 110 and the back outer card 115 each contain a thumb notch, 120 and 125, respectively. The front outer card 110 further includes a first window 130 and a second window 135 for selectively displaying information. The outer card 100 may also include printed text 140 or other printed material. Both the front outer card 105 and the back outer card 110 features holes 150 through which a rivet is inserted to assemble the parts of the business card.

FIG. 1B is a top view of the inner disk in one embodiment of the invention.

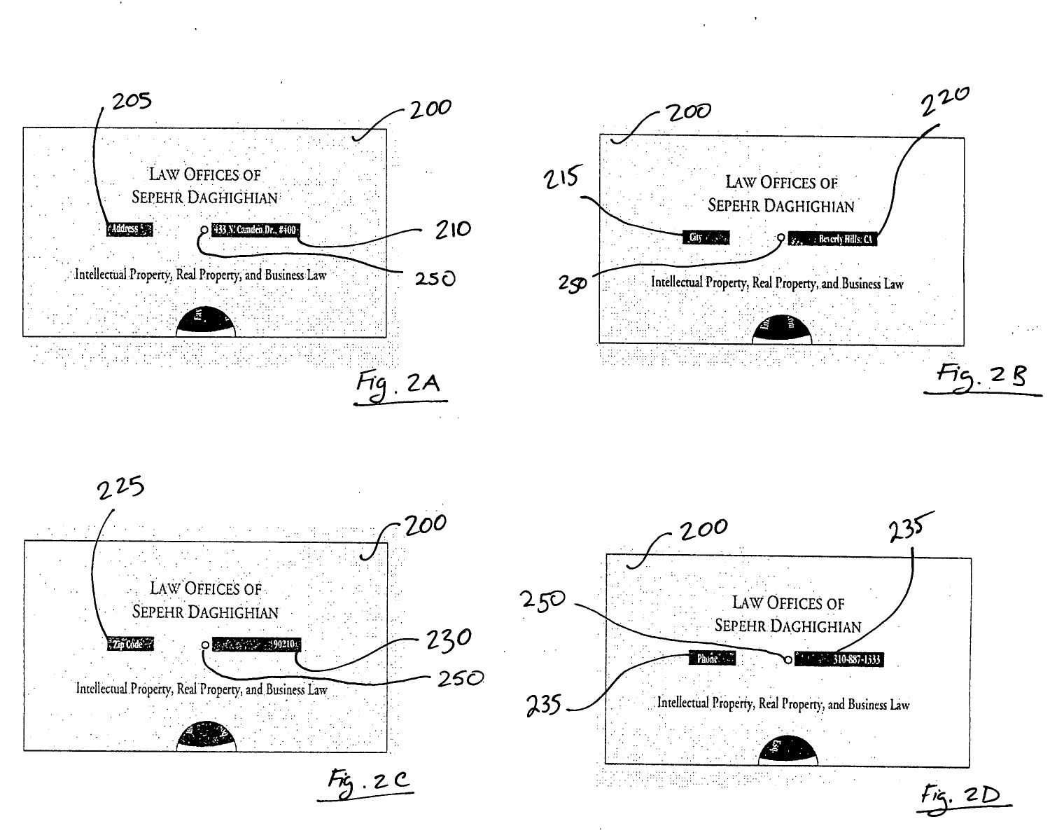

FIGS. 2A, 2B, 2C, and 2D are top views of the business card 200 invention while selectively displaying different information. In each of the figures, an assembled business card 200 is illustrated with a rivet 250 through the center of the disk in order to secure the parts of the business card 200. In FIG. 2A the inner disk is aligned to selectively display “Address” in the first window 205 and address information in the second window 210. In FIG. 2B the inner disk is aligned to selectively display “City” in the first window 205 and city information in the second window 210. In FIG. 2C the inner disk is aligned to selectively display “Zip Code” in the first window 205 and zip-code information in the second window 210. In FIG. 2D the inner disk is aligned to selectively display “Phone” in the first window 205 and phone number information in the second window 210.

I claim:

1. A business card, comprising:
an outer card, said outer card featuring one or more cut-outs,
an inner disk, said inner disk featuring printed information that may be viewed through said cut-outs, and
a means for rotatably fastening said inner disk to said outer card.

2. A business card according to claim 1, wherein said outer card is rectangular in shape and approximately 3-½ inches by 2 inches in size.

3. A business card according to claim 1, wherein said printed information includes printed information related to one or more of the following: name, address, phone number, fax number, email address, website, company, and/or position.

4. A business card, comprising:
an outer card, said outer card being approximately 3-½ inches by 2 inches in size and comprised of a rectangular sheet of approximately 7 inches by 2 inches that is folded in half lengthwise,
an inner disk, said inner disk being generally circular and under 2 inches in diameter and featuring printed information,
said outer card further including two or more cut-outs for viewing said printed information on said inner disk,
said outer card further featuring one or more cut-outs for rotating said inner disk, and
a means for rotatably fastening said inner disk to said outer card.

5. A business card according to claim 4, wherein said outer card features two cut-outs for viewing said printed information, said printed information comprising category information and corresponding cardholder's information, said cut-outs being configured such that, when said category information is displayed in the first cut-out, corresponding cardholder's information is displayed in the second cut-out.

6. A business card according to claim 5, wherein said category information is related to one or more of the following: name, address, phone number, fax number, email address, website, company, and/or position.

7. A business card according to claim 4, wherein said means for rotatably fastening said inner disk to said outer card comprises a rivet.

8. A business card according to claim 4, wherein said category information comprises branch locations and said corresponding cardholder's information comprises contact information related to said branch locations.

9. A business card according to claim 4, wherein one or more of said two or more cut-outs for viewing said printed information is located on the front side of said business card and one or more of said two or more cut-outs for viewing said printed information is located on the back side of said business card.

10. A business card according to claim 4, wherein said printed manner comprises an image of a globe.

11. A business card according to claim 4, wherein said printed matter comprises two or more images that relate to one another such that by rotating said disk, said two or more images are animated.
